(19) United States
(12) Patent Application Publication
(10) Pub. No.: US 2019/0275943 A1
(43) Pub. Date: Sep. 12, 2019

(54) EXTERIOR MIRROR ASSEMBLY FOR A MOTOR VEHICLE

(71) Applicant: Magna Mirrors Holding GmbH, Sailauf (DE)

(72) Inventors: Jean-Dominique Cretin, Sant Cugat del Valles (ES); Mirko Schell, Buergstadt (DE); Thomas Horvath, Darmstadt (DE); Frank Weimer, Wertheim (DE); Denis Rouard, Neunkirchen (DE); Felix Schnellbach, Freudenberg (DE); Peter Krebs, Mombris (DE)

(21) Appl. No.: 16/296,286

(22) Filed: Mar. 8, 2019

Related U.S. Application Data
(60) Provisional application No. 62/688,469, filed on Jun. 22, 2018.
(60) Provisional application No. 62/653,019, filed on Apr. 5, 2018.
(60) Provisional application No. 62/653,016, filed on Apr. 5, 2018.
(60) Provisional application No. 62/640,054, filed on Mar. 8, 2018.

(51) Int. Cl. B60R 1/07; B60R 1/12; F16J 15/06

(52) U.S. Cl. CPC B60R 1/07; F16J 15/061; B60R 1/1207

(57) ABSTRACT

An exterior mirror assembly for a vehicle includes a mirror head having a mirror housing and a reflective element, which is disposed so as to be adjustable at the mirror housing. The mirror assembly includes a mirror base or mounting base and an actuator for electric inward folding. The mirror assembly includes a sealing element that seals between the mirror head and the mirror base at least when the mirror head is in a use or extended position. When the mirror head is pivoted between the use position and a folded or stowed position, the sealing element is disengaged from the mirror head or the mirror base to allow for reduced friction pivoting of the mirror head relative to the mirror base. The sealing element may be mechanically moved to disengage or may disengage responsive to an electromagnetic element. The mirror assembly may include a light/indicator module.

### CROSS REFERENCE TO RELATED APPLICATIONS

The present application claims the filing benefits of U.S. provisional application Ser. No. 62/688,469, filed Jun. 22, 2018, U.S. provisional application Ser. No. 62/653,019, filed Apr. 5, 2018, U.S. provisional application Ser. No. 62/653,016, filed Apr. 5, 2018, and U.S. provisional application Ser. No. 62/640,054, filed Mar. 8, 2018, which are hereby incorporated herein by reference in their entireties.

### TECHNICAL FIELD OF THE INVENTION

The present invention relates generally to the field of exterior mirror assemblies for vehicles, and in particular to the field of electrically inward folding exterior mirror assemblies and/or of exterior mirror assemblies which include an indicator light insert.

### BACKGROUND TO THE INVENTION

It is known for an exterior mirror assembly for a motor vehicle to be provided that, for example, includes a powerfold or breakaway or inwardly folding mirror assembly such as, for example, an electrically operated inward folding mirror in which the mirror head by way of an electrically operated actuator is pivotable between a driving or use position and an inwardly folded or parking position.

Exterior mirror assemblies that include an indicator light are generally known. This herein are additional indicator signal devices in motor vehicles which are becoming ever more popular and which enhance the safety of the vehicle, on the one hand, and improve the aesthetics of the vehicle, on the other hand. Such an indicator light, or else other lights in the exterior mirror assembly, are connected to the cable harness or the vehicle electricals, respectively, of the vehicle by way of catches.

### SUMMARY OF THE INVENTION

The present invention provides an exterior mirror assembly that is attached to a mirror base or mirror foot at a side of an equipped vehicle, and that includes an actuator system for the electric inward folding so as to, in response to a user input, pivot the mirror head of the mirror assembly between a driving or use position and an inwardly folded or parking position. The mirror assembly includes a module for the electric inward folding, the module having an electrically operated actuator that is activated for pivoting the mirror head in relation to the mirror base, on account of which an interface, provided with cams, between the blocking disc of the module for the electric inward folding and a lift plate, elevates the lift plate (and not the entire mirror head) in relation to the mirror base so as to reduce any friction between the base and the cut line seal disposed about the circumference of the lift plate during the pivoting movement of the mirror head. The mirror assembly thus provides that the cut line seal is elevated or disengaged without lifting the mirror head per se.

In accordance with another aspect of the present invention provides an exterior mirror assembly that is attached to a side of an equipped vehicle and includes an actuator system for the electric inward folding for pivoting the mirror head of the mirror assembly between the driving or use position and the inwardly folded or parking position in response to a user input. The mirror assembly includes a movable seal which provides sealing between the mirror head and the base part of the mirror assembly and (on account of an applied magnetic field) is movable or disengagable so as to establish a gap between the mirror head and the base part during the pivoting of the mirror head, and which thus improves the activation of the electrically inward folding mirror.

In accordance with a first embodiment, the seal is disposed at or on the mirror base. The seal comprises an electromagnet which, when activated, generates a magnetic field and pulls the sealing lip of the seal away from the mirror head. When the actuator for the electric inward folding pivots the mirror head between the inwardly folded position and the driving position, the electromagnet is operated so as to pull the sealing lip toward the mirror base or mirror foot and away from the mirror head, such that the mirror head does not engage with the seal during the pivoting of the mirror head and thus does not slide on the seal. Optionally, the seal may be disposed at or on the mirror head, on account of which the electromagnet, when activated, pulls the sealing lip toward the mirror head and away from the mirror base, such that the mirror base does not engage with the seal during the pivoting of the mirror head in relation to the mirror base and thus does not slide on the seal.

In accordance with another aspect of the present invention, an external mirror assembly for a motor vehicle includes an indicator light insert, wherein the indicator light insert is disposed so as to emit an indicator light to the front in the travel direction, and wherein the indicator light insert and the exterior mirror are situated in the use position. The indicator light insert includes a sealing element on the lens of the indicator light insert, so as to provide improved sealing of the indicator light insert on the mirror cladding or on the mirror housing or on the mirror cover cap.

According to another aspect of the present invention, a vehicle exterior mirror assembly includes an indicator light insert that is disposed on a mirror casing or cladding of the exterior mirror assembly. The indicator light insert comprises a housing part, a light source, and a lens, wherein the lens is disposed in front of the light source and is fastened to the housing part. The indicator light insert comprises a sealing element that is disposed on the lens, and the sealing element engages with an internal face of the mirror casing or cladding and seals in relation to the mirror casing or cladding.

The lens includes a visible part which protrudes through an opening of the mirror casing or cladding, and a hidden part which is disposed behind the mirror casing or cladding. The sealing element is disposed between the hidden part and the internal face of the mirror casing or cladding and is disposed between side walls of the visible part and peripheries of the mirror casing or cladding which surround the opening.

According to yet another aspect of the present invention, an exterior mirror assembly includes a connector system for a light module, in particular an indicator light insert. The connector system provides first and second locking elements or catches for providing a double locking mechanism of a vehicle cable connector having a receptacle part or a socket of the light module.

According to another aspect of the present invention, the connector system includes a light module, which comprises a housing and a light that is disposed at or on the housing, and a cable connector at one end of a vehicle cable harness. The housing comprises a receptacle part that is configured for receiving the cable connector and for electrically connecting to the cable connector. The housing includes a first housing connector that, when the cable connector is received in the receptacle part, engages with a first catch of the cable connector. The housing includes a second housing connector that is fastened so as to be pivotable on the receptacle part. When the cable connector is received in the receptacle part and when the housing connector is engaged with the first catch of the cable connector, the second housing connector pivots onto and across part of the cable connector so as to engage with second catches on the cable connector and to thus firmly hold the cable connector on the housing.

The second housing connector, by way of a hinge element that is molded (such as, for example, by a plastics-material or polymer injection-molding process that configures the parts as an integral plastics-material or polymer structure) as part of the housing and of the second housing connector, can be fastened so as to be pivotable at or on the receptacle part. The housing connector can be configured (such as, for example, by way of the injection-molding process) at a connection location of the hinge element and of the housing. The second housing connector comprises a pair of lateral tabs that partially surround the cable connector so as to engage with respective second catches on mutually opposite sides of the cable connector.

These and other objects, advantages, purposes and features of the present invention will become apparent upon review of the following specification in conjunction with the drawings.

### BRIEF DESCRIPTION OF THE DRAWINGS

FIG. 1 is a perspective view of an exterior mirror assembly which is disposed on the side of a vehicle;

FIG. 2 is a plan view of the exterior mirror assembly, wherein the mirror head is pivoted to a deployed or use position;

FIG. 3 is a plan view of the exterior mirror assembly, wherein the mirror head is pivoted to an inwardly folded or non-use position;

FIG. 4 is an exploded perspective view of an exterior mirror assembly and shows the cut line seal which for reducing wind noise seals the gap between the mirror head and the mirror base;

FIG. 5 shows sectional views of the lift plate and the seal which show the lift plate in the lowered position thereof (wherein the seal seals the gap between the mirror head and the mirror base) and in the elevated position thereof (wherein the seal and the lift plate for reducing friction during the rotation or pivoting of the mirror head are elevated in relation to the mirror base without the mirror head being elevated)

FIG. 6 is an exploded perspective view of the actuator or module for the electric inward folding, having the blocking disc, the lift disc, and the seal, as well as the module cover;

FIG. 6′ is an exploded perspective view of the actuator or module for the electric inward folding, having a blocking disc, a lift plate, and a seal, as well as a module cover, and an upper cover of the mirror foot, in a further embodiment of the exterior mirror assembly according to the invention;

FIG. 7 is an exploded perspective view of the actuator or module for the electric inward folding, having the blocking disc, the lift plate, as well as the module cover according to FIG. 6;

FIG. 7′ is an exploded perspective view of the actuator or module for the electric inward folding, having the upper cover of the mirror foot, the lift plate, as well as the module cover according to FIG. 6′;

FIG. 8 is a perspective and partially sectional view of the module for the electric inward folding, the mirror head, and the mirror base, showing the lift plate in the lowered position thereof;

FIG. 9 is another perspective and partially sectional view of the module for the electric inward folding, the mirror head, and the mirror base, showing the lift plate in the elevated position thereof;

FIGS. 10A-D are perspective sectional views of details which show the sequences of the inward folding of the mirror head, on account of which it is effected that the lift plate and the seal move from the lowered position (FIG. 10A) to the elevated position (FIG. 10D);

FIGS. 10A′-C′ are perspective sectional views of details which show the sequences of the inward folding of the mirror head according to the further embodiment in FIGS. 6′, 7′, on account of which it is effected that the lift plate with the seal move from the lowered position (FIG. 10A′) to the elevated position (FIG. 10C′);

FIGS. 11A-D are perspective sectional views which show the sequences of the inward folding of the mirror head, on account of which it is effected that the lift plate and the seal move from the elevated position (FIG. 11A) to the lowered position (FIG. 11D);

FIG. 12 shows the cam track on the lift plate which the cams on the blocking disc engage with;

FIG. 13 is a perspective view of the blocking disc;

FIG. 14 is a perspective view of an exterior mirror assembly which is disposed on the side of a vehicle;

FIG. 15 is a plan view of the exterior mirror assembly, wherein the mirror head is pivoted to a deployed or use position;

FIG. 16 is a plan view of the exterior mirror assembly, wherein the mirror head is pivoted to an inwardly folded or non-use position;

FIG. 17 shows another view of the exterior mirror assembly;

FIG. 18 is a sectional view of the mirror assembly of FIG. 17, which shows an abutment gap seal between the mirror head and the fastening base of the mirror assembly;

FIG. 19 is an enlarged sectional view of the mirror assembly of FIG. 17;

FIG. 20 is a sectional view of an exterior mirror assembly having an electromagnetically controlled abutment seal according to the present invention;

FIGS. 21-23 are enlarged sectional views of the abutment seal, where the abutment seal, by way of electromagnetic control, is bent from a sealing state (FIG. 21) to a non-sealing state (FIG. 23);

FIGS. 24-26 are enlarged sectional views of another abutment seal, where the abutment seal, by way of electromagnetic control, is deformed from a sealing state (FIG. 24) to a non-sealing state (FIG. 26);

FIG. 27 is an enlarged sectional view of another abutment seal in the sealing state thereof;

FIG. 28 is a perspective view of a vehicle having an exterior mirror of the present invention;

FIG. 29 is a perspective view of an indicator light insert for an exterior mirror assembly;

FIG. 30 is a sectional view of an indicator light insert having a sealing lip about a circumference of a housing of the indicator light insert;

FIG. 31 is a sectional view of another indicator light insert having a sealing lip molded on the lens, according to the present invention;

FIG. 32 is a perspective view of a known light having a vehicle cable and a connector which is separated from the lamp housing;

FIG. 33 is another perspective view of the known light of FIG. 1, showing a cable connector plugged into a socket of the lamp housing;

FIG. 34 is an exploded perspective view of a connector and a socket according to the present invention;

FIG. 35 is a perspective view of the connector and the socket of FIG. 3, in which the connector is plugged into the socket such that a first catch engages with the socket; and

FIG. 36 is a perspective view of the connector and the socket of FIG. 4, in which the secondary locking mechanism of the socket on the connector is pushed downward so as to fix the connector to the socket.

### DESCRIPTION OF THE PREFERRED EMBODIMENTS

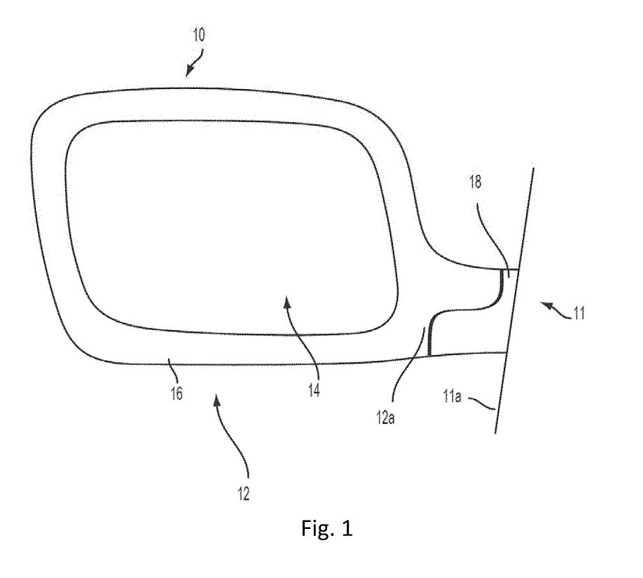

Referring now to the drawings and the illustrative embodiments depicted therein, an exterior rearview mirror assembly 10 for a vehicle 11 includes a mirror head 12 that includes a mirror reflective element 14 received in and/or supported at or by a mirror shell or casing 16 of the mirror head portion 12 (FIG. 1). The mirror head portion 12 includes a lower housing or mounting portion or lower receptacle part or fastening part 12a that is pivotally or movably mounted to or attached at a mirror mounting arm or base or portion or mirror foot 18. The mirror assembly 10 comprises a powerfold mirror (where the mirror head portion may be pivoted via an actuator assembly or adjustment device so as to be electrically inwardly foldable), and may comprise a breakaway mirror (where the mirror head portion may be manually pivoted about the mounting arm or base). The mounting arm or base 18 of mirror assembly 10 is mounted at the side 11a of a host or subject vehicle 11, with the reflective element 14 providing a rearward field of view along the respective side of the vehicle to the driver of the vehicle, as discussed below.

The exterior mirror assembly 10 is usually also embodied so as to be manually downwardly foldable (wherein the mirror head can be manually pivoted about the mirror foot). The mirror base 18 of the mirror assembly 10 is attached to the side 11a of a motor vehicle 11, wherein the reflective element 14 provides the driver of the vehicle with a rearward field-of-view along the respective side of the vehicle.

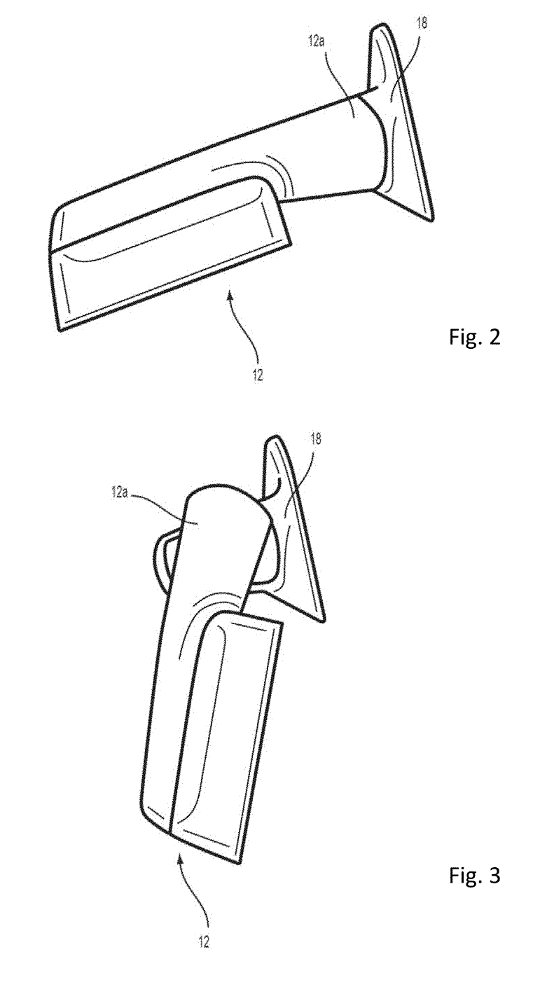

The mirror assembly 10 is embodied so as to be electrically inwardly foldable and includes an actuator 19, which is activatable so as to pivot the mirror head 12 (which comprises the mirror housing 16 and the reflective element 14) in relation to the fastening arm or the fastening base 18, respectively. The actuator 19, in response to a user input, acts so as to pivot the mirror head 12 between a use or drive position (FIG. 2) and an inwardly folded or parking position (FIG. 3). The mirror head can also be manually pivoted either to the use position or the inwardly folded position. The mirror head can selectively also be pivoted to a downwardly folded position which is situated at the very front.

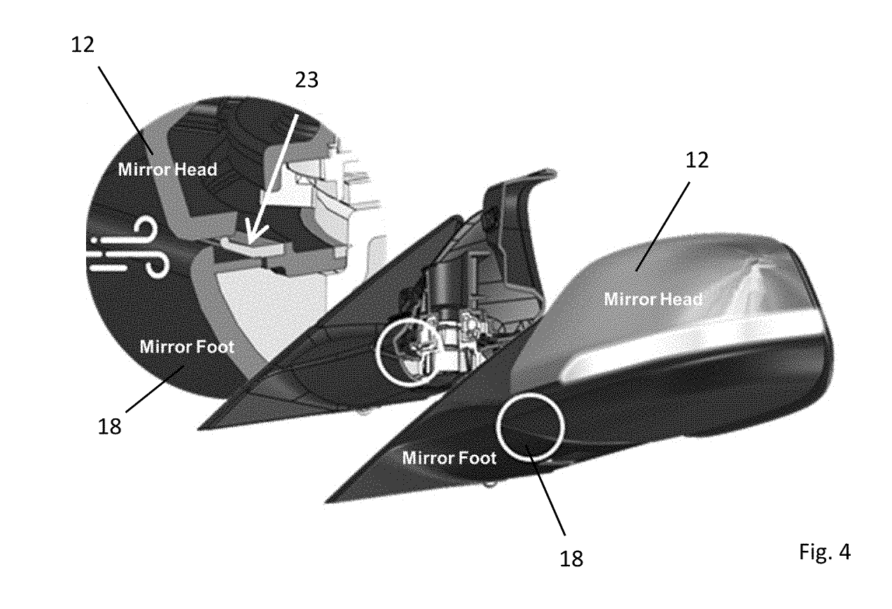

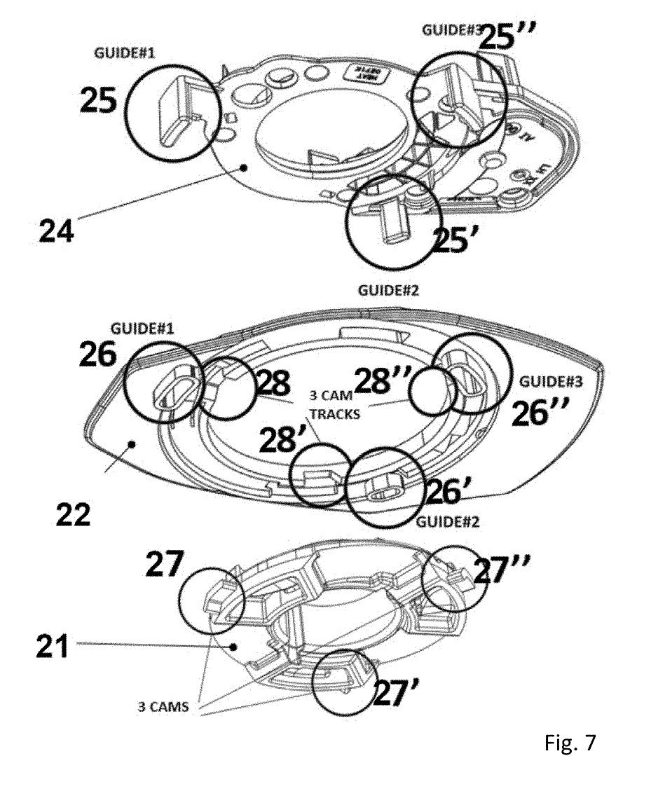

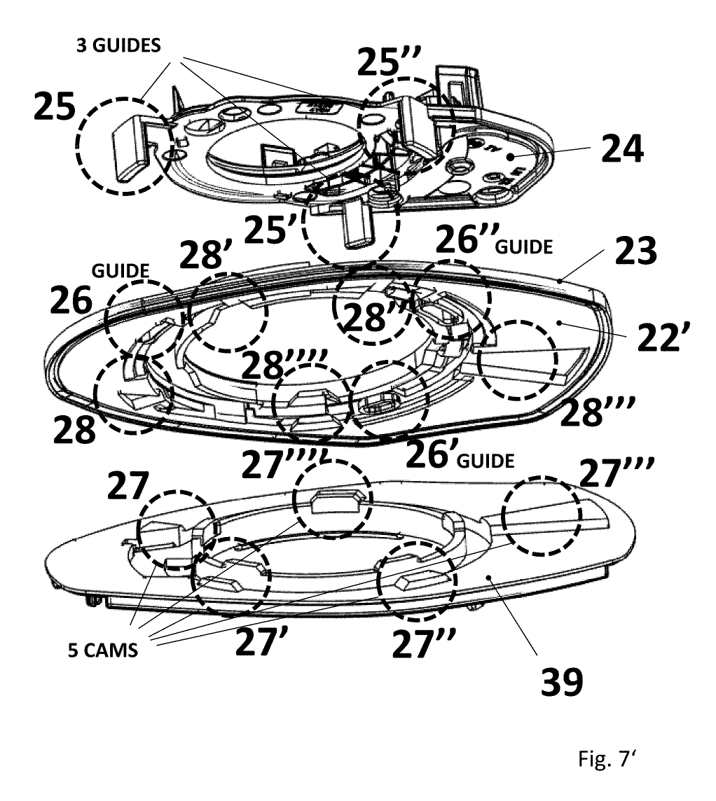

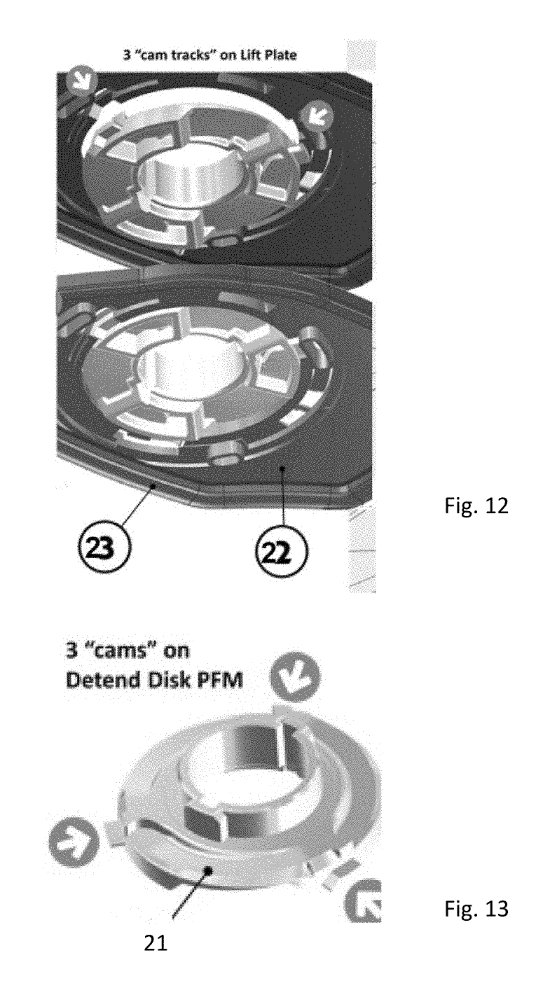

As is shown in FIG. 4, the mirror assembly has a seal or sealing lip or cut line seal 23 that is disposed between the mirror head 12 and the mirror base or the mirror foot 18, so as to seal the gap about the circumference of the interface and to thus limit wind noise when the mirror head 12 is situated in the use position thereof and the vehicle is driven. The space (required by virtue of components and assembly tolerances) between the mirror head and the mirror base or the mirror foot generates wind noise and dust/dirt ingress into the mirror. The seal or sealing lip or cut line seal 23 is therefore disposed between the mirror head 12 and the mirror base 18 so as to avoid such problems. Friction on the sealing lip during the inward folding (electric inward folding) leads to wear and requires a higher force applied by the actuator (and higher power consumption), and the stick-slip effect often leads to noise. The present embodiment according to the invention and according to FIGS. 1-13 offers a solution which avoids or minimizes such friction during the inward folding.

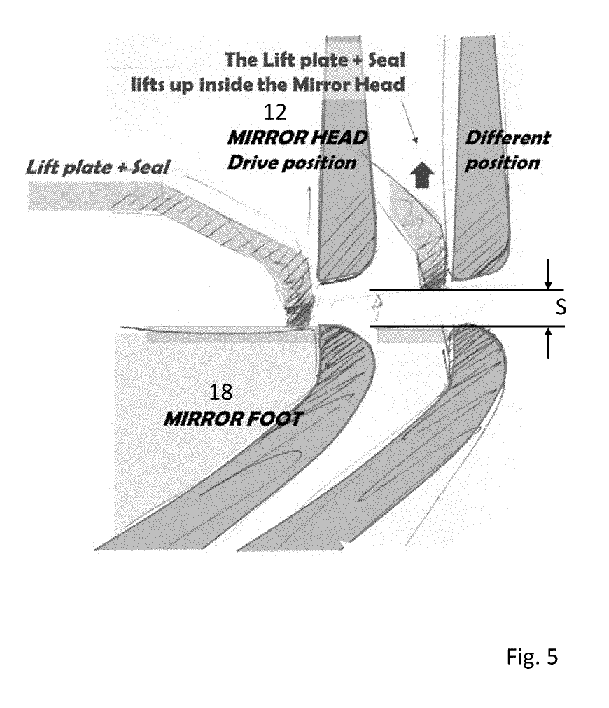

The mirror actuator or the powerfold module for the electric inward folding of the mirror assembly of the present invention is activated so as to elevate a lift plate of the module or actuator for the electric inward folding of the mirror head in relation to the mirror base (and in relation to the mirror head), so as to permit reduced friction or reduced resistance when pivoting the cut line seal 23 between the mirror head 12 and the mirror base 18 between the use position and the inwardly folded position. As is shown in FIG. 5, the extent of elevation is sufficient for elevating the lift plate 22 and the seal 23 in relation to the mirror head 12 and the mirror base 18 (when the mirror head is pivoted from the use position thereof to the inwardly folded position), such that the seal 23 is disengaged from the mirror base 18 without elevating the mirror head 12 in relation to the mirror base. When the mirror head 12 is pivoted back to the use position thereof, the lift plate 22 and the seal 23 are lowered such that the seal 23 re-engages with the mirror base 18 so as to close the gap between the mirror head 12 and the mirror base 18 and to seal the mirror head 12 in relation to the mirror base 18.

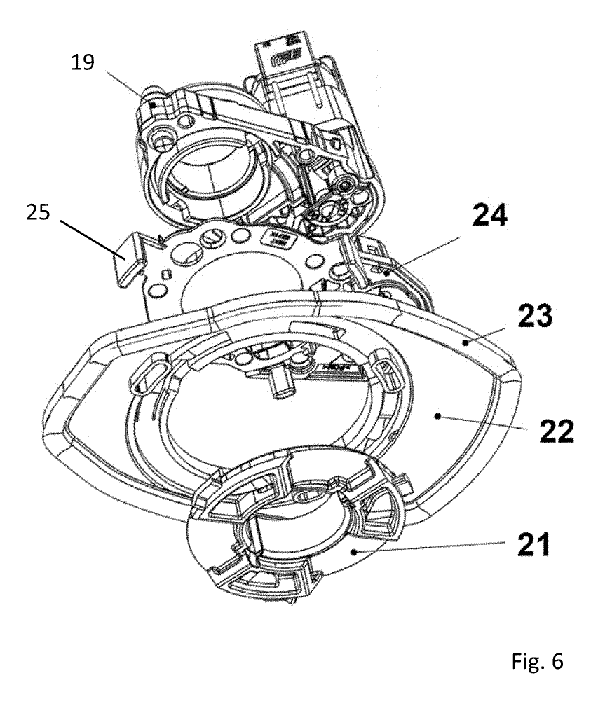

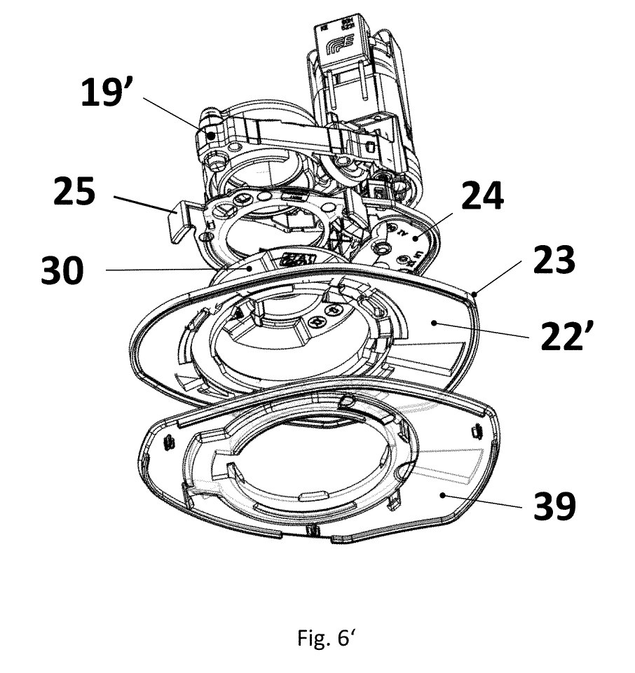

The actuator or the module 19 for the electric inward folding includes a motor that, for pivoting the mirror head 12 between the use position and the parking position thereof, rotates or pivots the module for the electric inward folding in relation to a pin of the mirror base 18. As is shown in FIG. 6, the module 19 for the electric inward folding includes a blocking disc 21, a lift plate 22, and a cut line seal 23, which is disposed about the circumference of the lift plate 22 (such as, for example, molded to the circumferential peripheral region of the lift plate or connected to the circumferential peripheral region of the lift plate by adhesive bonding or bonding or a press-fit). The blocking disc is configured so as to engage with a plate or disc of the mirror base so as to hold the module for the electric inward folding and the mirror head, either in the use position or in the parking position or inwardly folded position, in position in relation to the mirror base.

In the illustrated embodiment, the lift plate 22 is disposed between the blocking disc 21 and the lower cover 24 of the receptacle of the module 19 for the electric inward folding. The lower cover 24 includes guides or protrusions 25 that extend downward and through guides or receptacle slots 26 of the lift plate. The lift plate 22 thus rotates or pivots conjointly with the cover 24 (and the mirror head) but can however move vertically in relation to the cover (and the mirror head).

The lift plate 22 on the lower side thereof includes a plurality of (such as, for example, three or more) cam tracks 28, which engage on the upper side of the blocking disc 21. The blocking disc 21 on the upper side thereof includes a plurality of (such as, for example, three or more) cams 27, which engage with the cam tracks 28 of the lift plate 22. When the lift plate 22 is rotated or pivoted in relation to the blocking disc 21, the cams 27 move along the cam tracks 28 on account of which the lift plate (and the cut line seal) can be elevated or lowered in relation to the blocking disc (and the mirror base) and in relation to the cover 24 of the module 19 for the electric inward folding (and the mirror head). The lift plate 22 in the upper region thereof furthermore includes a plurality of flexible springs 29, wherein the flexible springs engage with the cover 24 and exert a downward force on the lift plate 22 so as to pre-tension the lift plate to the lowered position in relation to the cover 24 and the blocking disc 21.

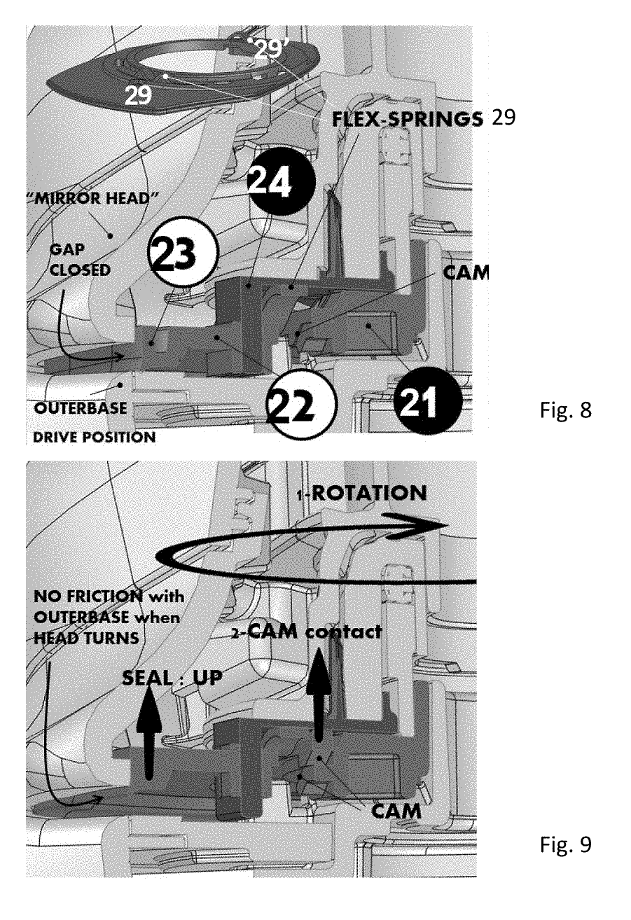

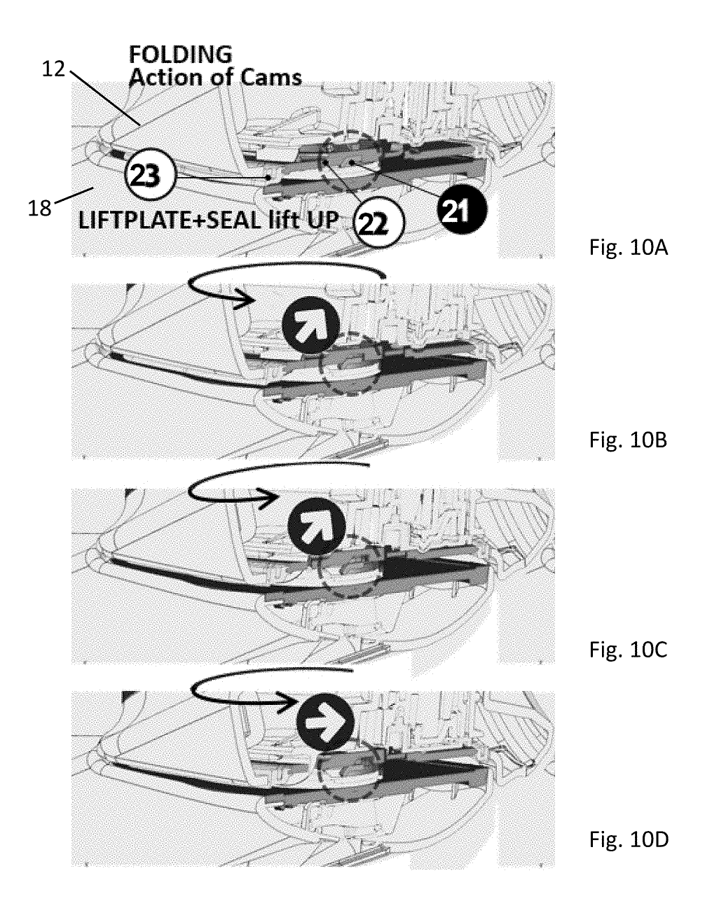

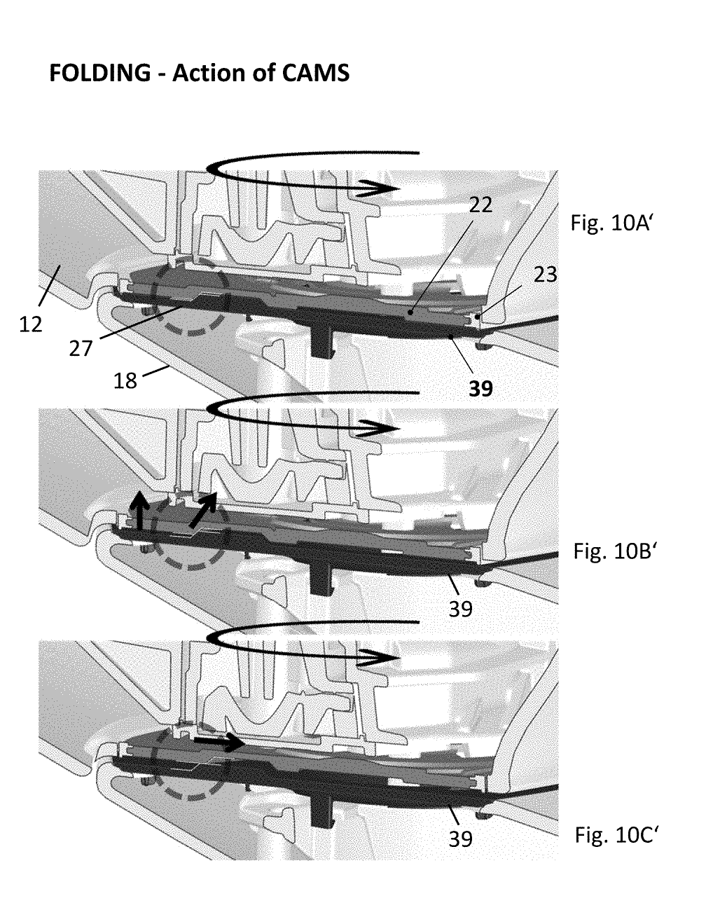

When the mirror head is situated in the use position, the cams 27 of the blocking disc 21 are received or embedded or nested in the cam tracks 28 (as is shown in FIGS. 8 and 10A), such that the lift plate 22 is situated in the lowered state thereof in relation to the blocking disc 21 and the mirror head and the mirror base. As can be seen in FIGS. 8 and 10A, the seal 23, when the lift plate is lowered, bears in a sealing manner on the mirror base so as to seal or close the gap between the mirror head 12 and the mirror base 18. The flexible springs 29, 29′ of the lift plate are held so as to be pre-tensioned in a sprung manner between the lift plate and the cover 24 in such a manner that the lift plate is pushed downward so as to be pre-tensioned relative to the blocking disc.

When the mirror head is pivoted or rotated (by activating the motor of the actuator for the electric inward folding) from the use position to the inwardly folded or parking position (and as can be seen in FIGS. 9 and 10A-D), the cams 27, 27′, 27″ of the blocking disc 21 slide along the ramp faces of the cam tracks 28, 28′, 28″ of the lift plate 22 so as to effect a vertical movement of the lift plate 22 in relation to the blocking disc 21. The lift plate, by virtue of the guides 25, 25′, 25″ that are received in the guide slots 26, 26′, 26″, rotates or pivots conjointly with the cover 24 but also moves vertically in relation to the cover 24. Such a vertical movement of the lift plate 22 in relation to the blocking disc 21 and the cover 24 moves the cut line seal 23 in relation to the mirror head and in relation to the mirror base. As is shown in FIGS. 9 and 10B-10D, the vertical movement, or the elevation, of the lift plate opens the gap between the mirror head and the mirror base. Since the lift plate 22 (and the seal) are then elevated in relation to the blocking disc 21 and the mirror base 18, the mirror head 12 pivots or rotates without any contact or by way of reduced contact between the cut line seal 23 and the mirror base 18, and thus exhibits reduced or minimum friction or resistance when pivoting toward and to the inwardly folded position.

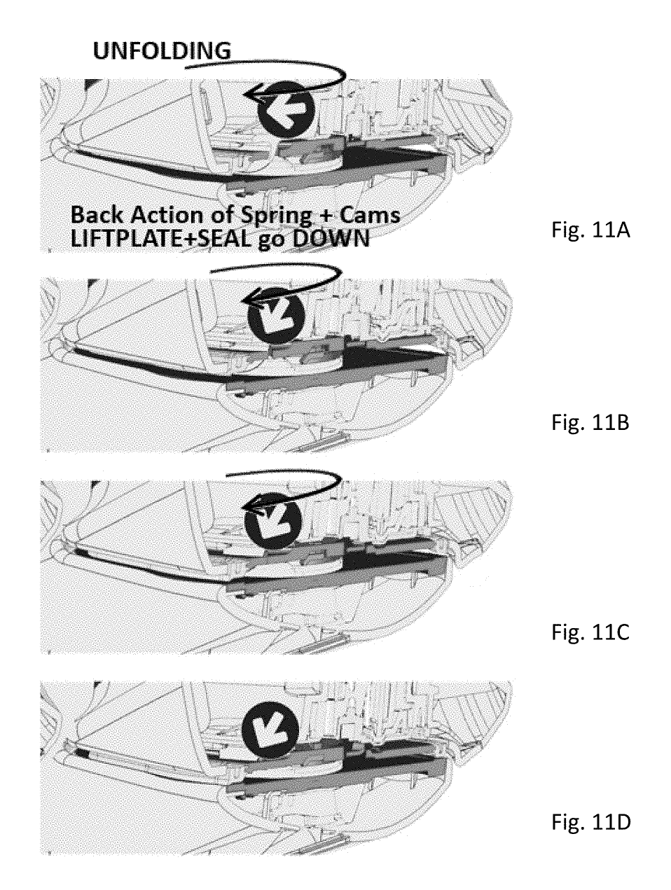

When the mirror head is pivoted from the parking position or inwardly folded position thereof back to the use position (wherein the lift plate is still elevated and the seal is disengaged from the mirror base), the mirror head 12 pivots conjointly with the still elevated lift plate 22 back to the use position. When the mirror head 12 approaches the use position, the cams 27 approach the cam tracks 28 and move along the cam tracks and into the cam tracks so as to be received are received in or nested in the cam tracks (FIGS. 11A-11D). The flexible springs or pre-tensioning or biasing elements 29 push or urge the lift plate 22 downward such that the lift plate is lowered while the cams move into the cam tracks 28 and are received or embedded or nested therein (FIGS. 8 and 11D). When the cams are embedded in the cam tracks, the lift plate 22 and the seal 23 are lowered and the seal 23 bears in a sealing manner on the mirror base 18 and closes the gap between the mirror head 12 and the mirror base 18.

The mirror assembly thus includes three (or more and at least two) cams 27, 27′, 27″ on the blocking disc 21 that, with the aid of respective cam tracks 28, 28′, 28″ on the lift plate, elevates a lift plate (conjointly with the cut line seal that is fastened thereto or disposed or molded thereon) within the mirror head when the actuator for the electric inward folding commences with rotating or pivoting or inwardly folding the mirror head. The rotation or pivotal movement of the mirror head 12 and of the cams and cam tracks has the effect that the lift plate 22 moves upward or downward in relation to the mirror head 12 and the mirror base 18, while the flexible springs 29, 29′ maintain the contact between the cams and the cam tracks and push the lift plate 22 downward. Since the lift plate 22 and the seal 23 are elevated during the pivoting of the mirror head 12 in relation to the mirror base 18, and the seal 23 is disengaged from the mirror base 18, there is reduced wear on the cut line seal and less or no noise is generated. The reduced current uptake (by the actuator motor) during the electric inward folding (by virtue of the reduced friction or the reduced resistance) leads to an increased life cycle for the actuator for the electric inward folding.

During the operation of the actuator for the electric inward folding, and as can be seen in FIGS. 10A-D, the actuator thus has the effect of pivoting the mirror head from the use position thereof (FIG. 10A) to the inwardly folded position thereof (FIG. 10D). When the mirror head is situated in the use position thereof (FIG. 10A), the cams are nested in the cam tracks and the seal 23 engages with the mirror base 18. In the initial operation of the actuator 19, the cams move along the ramp of the cam tracks so as to effect an upward movement of the lift plate 22 for disengaging the seal 23 from the mirror base 18 (FIGS. 10B-10C), such that there is only little or no contact between the seal 23 and the mirror base 18, on account of which the rotation or pivotal movement of the mirror head 12 in relation to the mirror base 18 is associated with reduced friction or reduced resistance, respectively.

After the elevation of the lift plate 22, the mirror head 12, by way of further rotatingly driving the actuator 19, is pivoted in relation to the mirror base 18 while the lift plate 22 remains in the elevated state thereof. The actuator 19 for the electric inward folding pivots the mirror head 12 further to and into the inwardly folded position (FIGS. 10D and 11A).

The operation of the mirror actuator 19 when pivoting the mirror head 12 from the inwardly folded position to the use position is shown in FIGS. 11A-D. When the actuator 19 is operated for pivoting the mirror head 12 to the use position, the motor drives the gear wheels thereof in the opposite direction, on account of which it is effected that the mirror head 12 (conjointly with the lift plate seal which is still disengaged from the mirror base) pivots in the opposite direction and to the use position. The lift plate 22 (and the seal) remain in the elevated position thereof during the pivoting movement to the use position. When the mirror head 12 approaches the use position, the cams for lowering the lift plate 22 and the seal 23 slide along the ramps of the cam tracks (FIGS. 11B, 11C). When the mirror head 12 reaches the use position, the cams are nested in the cam tracks and the lift plate 22 and the seal 23 are lowered so as to close the gap between the mirror head 12 and the mirror base 18.

Instead of the cams being disposed at or on the blocking disc 21, the cams can selectively and as an alternative be disposed at or on the mirror base 18 or mirror foot. In the case of such a configuration, the guides or protrusions can be situated on the holder of the mirror.

In such a configuration, the lift plate 22 can selectively be pre-tensioned to an elevated position and (for disengaging the seal from the mirror head) can be moved to a lowered position when the mirror head 12 is pivoted from the use position thereof to the inwardly folded or parking position thereof. In the case of such a configuration, the interface provided with cams can be situated between the upper side of the lift plate and the lower side of the receptacle cover, and the guides can be part of the interface of the blocking disc 21 and the lift plate 22. The mirror actuator 19 or the module for the electric inward folding and the mirror assembly can otherwise function in a manner similar to that as has been discussed above, such that a detailed discussion of the mirror assembly does not have to be repeated here.

FIGS. 6′, 7′, 12A-12C show an alternative embodiment to the exterior mirror assembly described above in conjunction with FIGS. 1-13. The same components of the alternative embodiment are provided with the same reference signs and will not be described once again at this point.

As is shown in FIG. 6′, the module 19′ for the electric inward folding includes a blocking disc 30, a lift plate 22′, and a cut line seal 23′ that is disposed about the circumference of the lift plate 22′ (such as, for example, molded to the circumferential peripheral region of the lift plate or connected to the circumferential peripheral region of the lift plate by adhesive bonding or bonding or a press-fit), as well as an upper cover 39 of the mirror foot 18. The upper cover 39 is embodied as a disc-shaped annular element and is disposed at or on the side of the mirror foot 18 that is directed upward (toward the mirror head 12) and is connected in a rotationally fixed manner to the mirror foot 18.

The blocking disc 30 is configured so as to engage with a blocking disc assigned to the mirror foot 18 so as to hold the module for the electric inward folding and the mirror head, either in the use position or in the parking position or in the inwardly folded position, in position in relation to the mirror base. This blocking disc assigned to the mirror foot is known to the person skilled in the art and will not be described in more detail here. In the case of the alternative embodiment, the blocking disc 30 is embodied as a standard component and corresponds to a typical blocking disc of a known exterior mirror assembly having a power folding drive. This means that the blocking disc 30, as opposed to the embodiment described above, does not comprise any cams 27, 27′, 27″.

In the case of the embodiment visualized, the lift plate 22′ is disposed between an upper cover 39 assigned to the mirror foot 18 and the lower cover 24 of the module 19′ for the electric inward folding. The lower cover 24 includes guides or protrusions 25, 25′, 25″ which extend downward and through guides or receptacle slots 26, 26′, 26″ of the lift plate 22′. The lift plate 22′ thus rotates or pivots conjointly with the cover 24 (and the mirror head) but can move vertically (in the z-direction) in relation to the cover (and the mirror head).

The lift plate 22′ on the lower side thereof includes a plurality of cam tracks 28, 28′, 28″, 28′″, 28″″ that engage with corresponding cams 27-27″″ disposed on the upper side of the upper cover 39 of the mirror foot 18. When the lift plate 22′ is rotated or pivoted in relation to the upper cover 39, the cams 27-27″″ move along the assigned cam tracks 28-28″″, on account of which the lift plate 22′ can be conjointly elevated or lowered with the assigned sealed 23 in relation to the upper cover 39 of the mirror foot 18 and in relation to the cover 24 of the module 19′ for the electric inward folding. The lift plate 22′ in the upper region thereof furthermore includes a plurality of flexible springs, wherein the flexible springs engage with the cover 24 and exert a downward force on the lift plate 22′ so as to pre-tension or bias or urge the lift plate toward the lowered position in relation to the cover 24′ and the upper cover 39.

When the mirror head 12 is situated in the use position thereof, the cams 27-27″″ of the upper cover 39 are received or embedded in the cam tracks 28-28″″ (as is shown in FIG. 10A′), such that the lift plate 22′ is situated in the lowered state thereof in relation to the locking disc 21 and the mirror head and the mirror base. As can be seen in FIG. 10A′, the seal 23 when the lift plate 22′ is lowered bears in a sealing manner on the mirror foot 18 so as to seal or close the gap between the mirror head 12 and the mirror base 18. The flexible springs 29, 29′ of the lift plate are held so as to be pre-tensioned in a sprung manner between the lift plate and the cover 24 in such a manner that the lift plate is pushed downward so as to be pre-tensioned relative to the upper cover 39.

When the mirror head (by activating the motor of the actuator for the electric inward folding) is pivoted from the use position to the inwardly folded or parking position (and as can be seen in FIGS. 10A′-C′), the cams 27-27″″ slide along the ramp faces of the cam tracks 28-28″″ so as to effect a vertical movement of the lift plate 22′ in relation to the upper cover 39 of the mirror foot 18. The lift plate 22′, by virtue of the guides 25, 25′ 25″ which are received in the guide slots 26, 26′, 26″, rotates or pivots conjointly with the cover 24, but also moves vertically in relation to the cover 24. Such a vertical movement of the lift plate 22′ in relation to the upper cover 39 and the cover 24 moves the cut line seal 23 in relation to the mirror head and in relation to the mirror foot 18. As is shown in FIGS. 106′-10C′, the vertical movement or the elevation of the lift plate 22′ opens the gap between the mirror head 12 and the mirror base 18. Since the lift plate 22′ (and the seal) are then elevated in relation to the upper cover 39 and the mirror base 18, the mirror head 12 pivots or rotates without any contact or by way of reduced contact between the cut line seal 23 and the mirror base 18, and thus exhibits reduced or minimum friction or resistance when pivoting to the inwardly folded position.

When the mirror head 12 is pivoted from the parking position or inwardly folded position thereof back to the use position (wherein the lift plate is still elevated and the seal is disengaged from the mirror base), the mirror head 12 conjointly with the still elevated lift plate 22′ pivots back to the use position. When the mirror head 12 approaches the use position, the cams 27-27″″ approach the cam tracks 28-28″″ and move along the cam tracks and into the cam tracks. The flexible springs or pre-tensioning or biasing elements push or urge the lift plate 22′ downward such that the lift plate is lowered while the cams move into the cam tracks and are received or embedded or nested therein. When the cams are nested in the cam tracks, the lift plate 22′ and the seal 23 are lowered and the seal 23 bears in a sealing manner on the mirror base 18 and closes the gap between the mirror head 12 and the mirror base 18.

It is obvious to the person skilled in the art that the number of cams and assigned cam tracks can vary. The present invention provides a disengagable seal at the interface between the mirror head 12 and the mirror mounting 18, with the seal being engaged when the mirror head 12 is situated in the use position thereof for closing the gap between the mirror head 12 and the mirror base 18, and the seal being disengaged for permitting a free or low-friction movement of the mirror head 12 in relation to the mirror base 18. No friction is generated when a gap S (FIG. 5) is established between the seal 23 and the mirror base 18 during the inward folding/downward folding procedure. The present invention thus provides reduced noise and reduced friction during the operation of the actuator for the electric inward folding. Furthermore, the present invention provides such a disengagable seal in a cost-effective manner in that the invention provides the seal on an elevatable and lowerable plate that is elevated and lowered by way of cams, thus not requiring any additional gear wheels or drive elements for elevating the entire mirror head in relation to the mirror base.

Optionally, and in accordance with another alternative embodiment, the cams may be disposed on the upper cover 39 of the mirror foot 18. On account thereof, a commercially available blocking disc 30 of a module 19′ can be used, on account of which production costs can be reduced.

The number of cams and assigned cam tracks can of course vary. A high stability is achieved in the case of an embodiment described above having five cams.

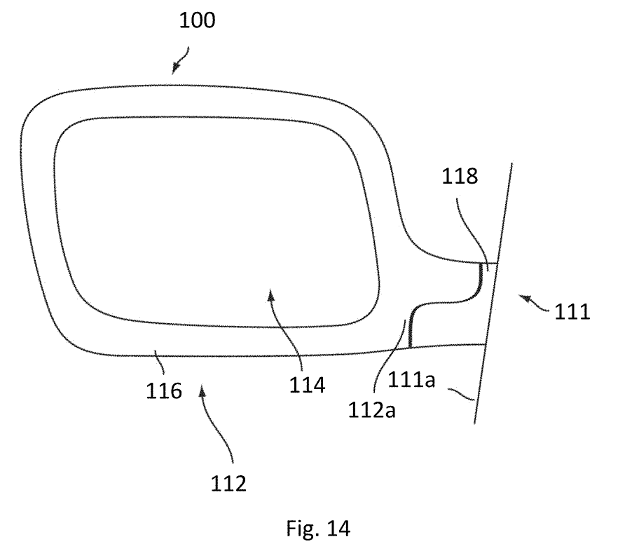

Referring now to FIGS. 14-27, another exemplary embodiment of an exterior mirror assembly according to the invention is shown. The exterior mirror assembly 100 for a vehicle 111 comprises a mirror head 112 having a mirror reflective element 114. The mirror reflective element 114 is received in a mirror housing 116 of the mirror head 112 and/or is supported thereon or on account thereof (FIG. 14). The mirror head 112 includes a lower housing part or fastening part 112a that is attached so as to be pivotable or movable on a fastening arm or a fastening base or a fastening part, or a mirror foot 118, respectively. The mirror assembly 110 is embodied so as to be electrically inwardly foldable (wherein the mirror head 112 can be pivoted by way of an actuator assembly or an adjustment device) and is furthermore also embodied so as to be mechanically inwardly foldable (wherein the mirror head can be manually pivoted about the fastening arm or the fastening base or the mirror foot 118, respectively). The fastening arm or the fastening base 118 of the mirror assembly 110 is attached to the side 111a of the motor vehicle 111 in such a manner that the reflective element 114 provides the driver of the vehicle with a rearward field-of-view along the respective side of the vehicle.

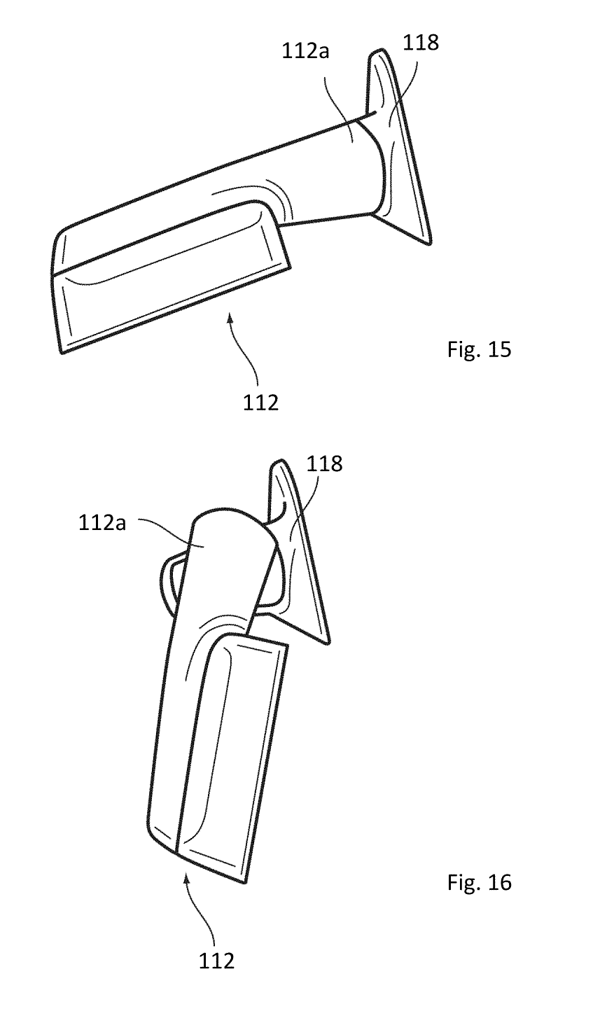

The exterior mirror assembly is embodied as an electrically inward foldable mirror assembly which includes an actuator which is activatable so as to pivot the mirror head 112 (comprising the mirror housing 116 and the reflective element 114) in relation to the fastening arm or the fastening base 118. The actuator is electrically powered or operated in response to a user input so as to pivot the mirror head 112 between a use position or driving position (FIG. 15) and an inwardly folded or parking position (FIG. 16). The mirror head is also manually pivotable either to the use position or the inwardly folded position. The mirror head can selectively also be pivoted to a downwardly folded position which is situated at the very front. A seal 119 is disposed along the interface between the fastening part 112a of the mirror head 112 and the fastening arm or the fastening base 118.

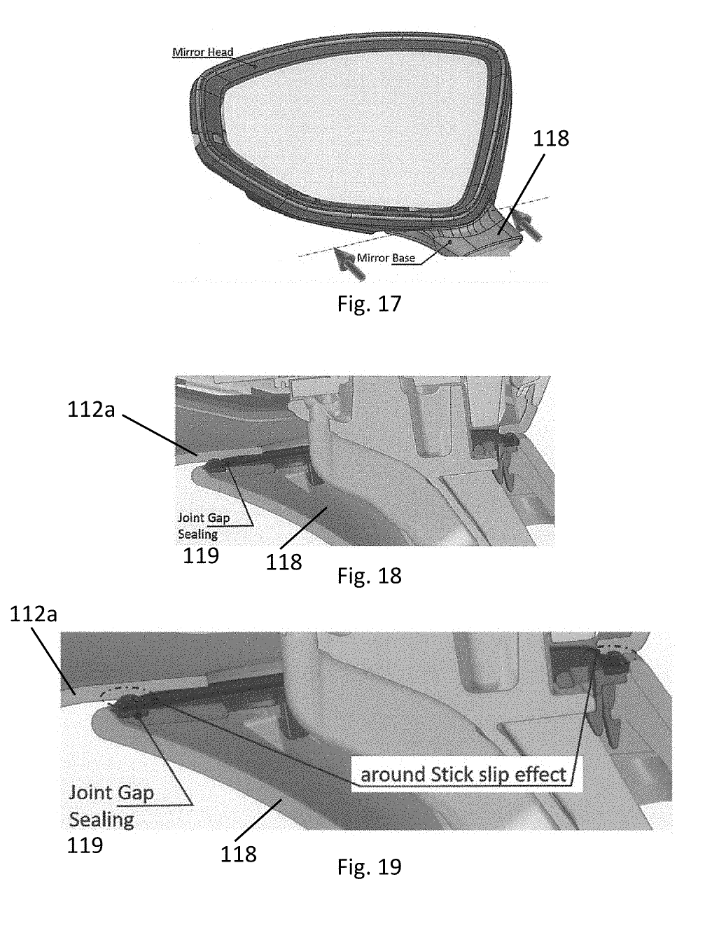

The seal 119 is fastened to the mirror foot or the mirror base 118, respectively, and engages with the mirror head at the connection point or on the interface between the mirror head 112 and the mirror base 118. The term “engages with” means that a seal of this type, as shown in FIGS. 17 to 19, seals the gap S (FIG. 23) existing between the mirror head and the mirror base. The seal 119 comprises at least one sealing lip 120 which, proceeding from a seal main body, in the use position of the exterior mirror assembly bears on the fastening part 112a of the mirror head 112.

As is shown in FIG. 19, the seal 119 is fastened to the mirror base 118, for example, and the sealing lip 120 of the seal 119, in the use position of the exterior mirror assembly, bears in a sealing manner on the lower side of the mirror head 112 in the region of the fastening part 112a. Of course, a reversed arrangement can also be chosen in which the seal is disposed on the mirror head and the sealing lip bears in a sealing manner on the mirror base 118.

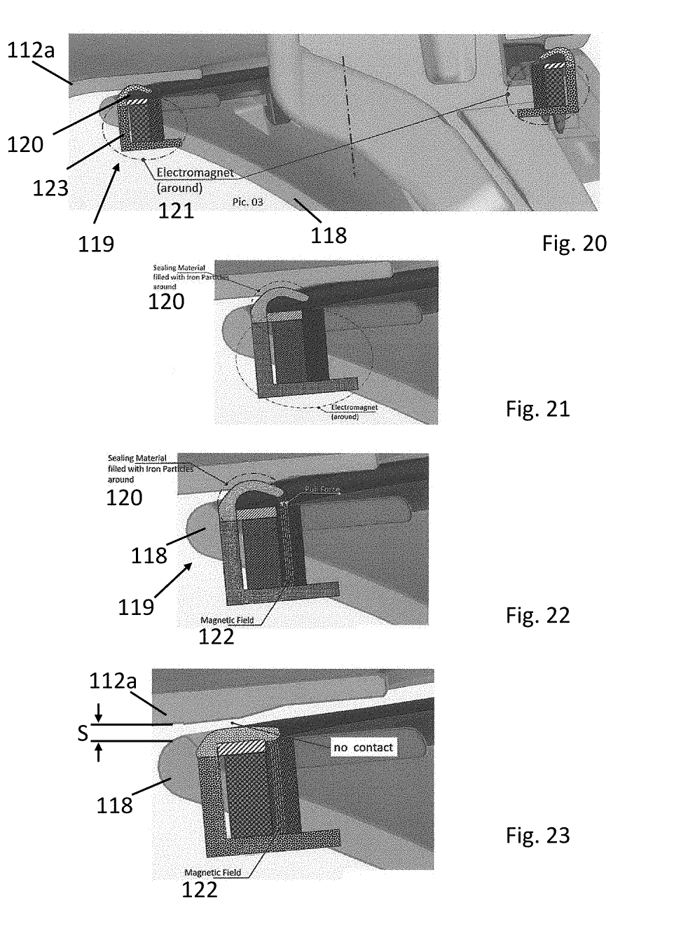

The exterior mirror assembly 100 of the present invention provides a seal which has an magnetic sealing lip or sealing element 120 (which comprises a magnetic or ferromagnetic material) that, on account of a magnetic field 122 generated by an electromagnet 121, is movable or deformable at the mirror assembly. For example, and with reference to FIGS. 20-23, the seal 119 can comprise a base part or a base ring 123 that is fastened to the mirror base 118, and a sealing element or a sealing lip 120 or a sealing ring that extends from the mirror base 118 in the direction toward the mirror head so as to seal in relation to the mirror head 112. The sealing lip 120 comprises a magnetic material (such as, for example, a rubber material which is filled with magnetic or ferromagnetic particles such as, for example, iron or the like), and the sealing assembly includes an electromagnetic element 121 which is capable of being operated so as to generate a magnetic field 122 (FIGS. 21 and 23) through the seal (for example through the base part and the lip part) so as to pull the sealing lip 120 to the base part 123 of the seal and away from the mirror head 112.

The seal 119 or the seal assembly comprises an annular element 124, wherein the base part of the seal 119 or the sealing assembly is configured so as to be fastened to the mirror mounting such that the sealing lip 120 protrudes generally upward toward the mirror head 112 and bears in a sealing manner on the lower side of the mirror head 112a. The electromagnet 121 is integrated in the base part and is electrically activated by electric power, which is provided when the actuator for the electric inward folding is electrically powered.

As shown in FIGS. 20-22, the sealing lip 119 bears on the mirror head 112 so as to provide a seal in the region of the connection point/the gap between the mirror head 112 and the mirror mounting 118. When the electromagnet 121 is activated, the sealing lip 119 is pulled away from the mirror head 112 (FIG. 23) such that the mirror head 112 can pivot in relation to the mirror base 118 without sliding and thus without the frictional resistance and the noises which are typically associated with such a pivoting movement.

The electromagnet 121 is activated by an electric signal that is generated in response to an activation of the mirror actuator for pivoting the mirror head 112 in relation to the mirror base 118. For example, when the mirror head 112 is situated in the use position thereof, the electromagnet 121 is not activated, and the sealing lip 120 engages with the mirror head 112 and seals in relation to the mirror head. When the mirror actuator for pivoting the mirror head 112 is activated to the inwardly folded position thereof (parking position), the electromagnet 121 for generating the magnetic field 122 for pulling or moving or drawing the flexible or deformable sealing lip 120 away from the mirror head 112 and toward the mirror base 118 is also activated such that the sealing lip moves or deforms so that a gap exists between the mirror head 112 and the sealing lip 120 (at least in such a manner that the friction forces between the mirror head and the sealing lip are reduced) so that a pivoting movement of the mirror head 112 is achieved without sliding (or by way of reduced sliding) on the sealing lip 120. The electromagnet 121 is deactivated once (or when) the actuator for the electric inward folding stops, and the sealing lip 120 returns to the initial sealing state thereof in which the sealing lip 120 is engaged with the mirror head.

The activation of the electromagnet can be performed in response to a current supply to the actuator for pivoting the mirror head. A control system can selectively activate the electromagnet in response to a signal for triggering the pivoting of the mirror head before any pivoting movement of the mirror head is performed, such that the lip is disengaged prior to the pivoting of the mirror head. Likewise, the control system can delay a deactivation of the electromagnet until the pivoting movement of the mirror head stops.

On account of the configuration of the exterior mirror assembly 100 having the seal 119 and the associated actuation during the inward folding/outward folding procedure, contact between the sealing lip 120 and the mirror head advantageously does not arise (or is at least partially or substantially reduced). A gap S, which is shown in FIG. 23, is created between the mirror head and the mirror base. In the absence of friction there are no stick-slip effects and also no squeaking noises which are typical of known sealing elements and mirror assemblies.

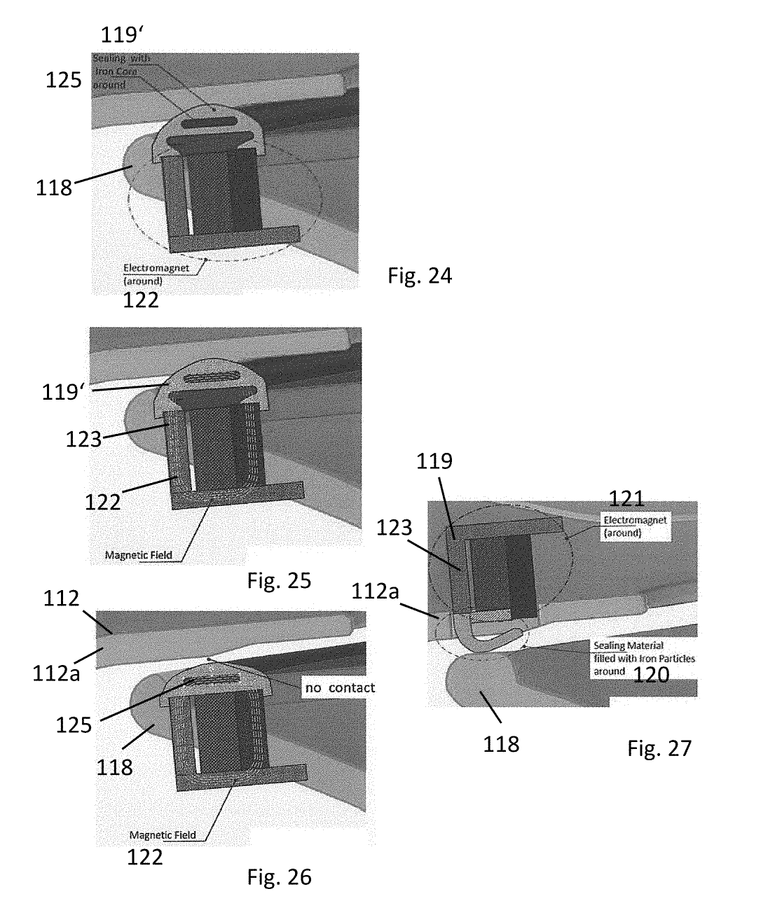

Optionally, the sealing element 119′ (FIGS. 24-26) can selectively be formed having a magnetic core element 125 so that the core element 125 when activating the electromagnet 121 is pulled away from the mirror head 112 and toward the mirror base 118, which causes deformation of the sealing element 119′ for moving or drawing a sealing face of the sealing element 119′ away from the mirror head 112. The sealing element 119′ can additionally be filled with a magnetic material so as to amplify the magnetic field and the tension force on the magnetic core element 125.

While the seal 119, 119′ is illustrated as a base part that is fastened to the mirror foot 118, the base part thereof can nevertheless also be fastened to the mirror head 112, wherein a sealing lip or sealing face (in which a magnetic material is embedded or which is filled with the magnetic material and/or has a magnetic core element) bears in a sealing manner on the mirror foot 118. Such an embodiment is shown in FIG. 27.

The present invention thus provides a seal at an interface between a mirror head 112 and a mirror mounting base 118, with the seal engaging the mirror head and mirror mounting base so as to seal the connection point or interface when the mirror head 112 is not pivoted in relation to the mirror mounting base 118, and with the seal disengaging so as to permit a free movement, or a movement with reduced friction, of the mirror head 112 in relation to the mirror mounting base 118. When a gap exists between the seal and the mirror head (or between the seal and the mirror mounting base) during the inward folding or outward folding procedure, no friction is generated on account of the sliding on the seal. The present invention thus provides reduced noises and reduced friction during the operation of the actuator for the electric inward folding.

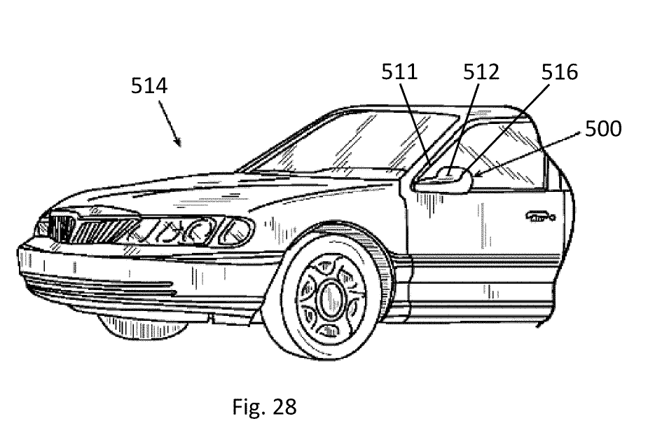

FIG. 28 shows in a perspective view yet one further embodiment of an exterior mirror assembly 500 having an integrated indicator light insert 550, which comprises a mirror foot 518 as well as a mirror head 512. The exterior mirror assembly 500 is fastened in a known manner to the external driver or passenger side 511, respectively, of the motor vehicle 514. The mirror head 512 herein is disposed so as to be adjustable or foldable, respectively, on the mirror foot 518 and has a mirror housing 516, which is typically composed of a thermoplastic plastics material. A reflective element, which is typically mounted on an adjustable mounting (not illustrated) disposed in the interior of the mirror housing 516, is inserted in a first receptacle opening of the mirror housing 516. The reflective element 514 provides the driver of the vehicle with a rearward field-of-view along the respective side of the vehicle and is not visible in the illustration of FIG. 28. The mirror housing 516 can be embodied in one part or a plurality of parts. The indicator light insert 550 is integrated in the mirror housing 516, or a housing portion of the mirror housing 516, respectively, and is held in a sealed manner as described hereunder. The indicator light insert 550, proceeding from a side of the mirror housing 516 that faces the vehicle, in the y-direction (transverse direction of the vehicle) herein extends across approximately the entire width of the mirror housing 516 up to an external side of the mirror housing 516 that faces away from the vehicle.

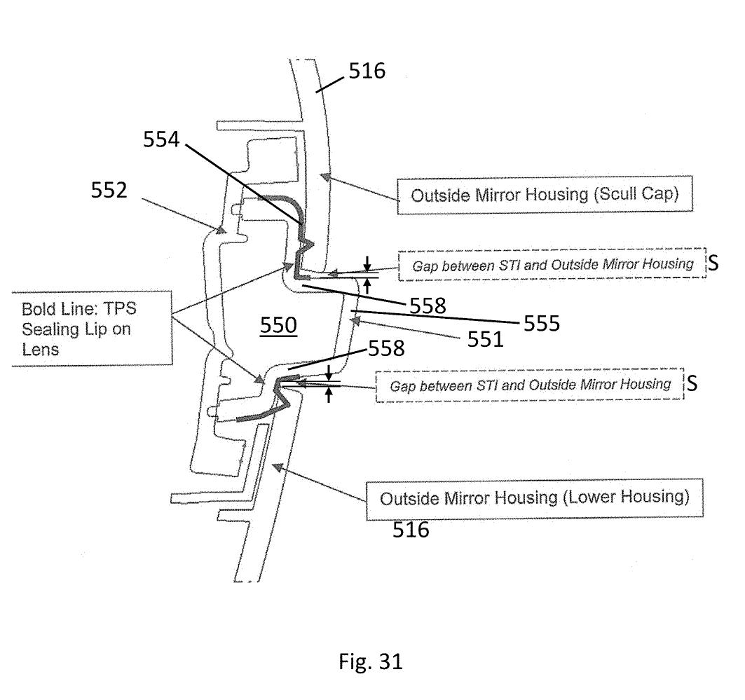

The indicator light insert 550 comprises a two-part housing which includes a front cover element having an at least partially light-permeable lens 551 and a rear cover shell 552. In the assembled state of the exterior mirror assembly 500, at least part of the lens 551, or part of the light-permeable region of the lens 551, protrudes through an opening formed in the mirror housing 516. This can be seen in the sectional illustration of FIG. 31. In one alternative embodiment, the front at least partially light-permeable region of the lens 551 can also be disposed in the opening in such a manner that the lens runs so as to be flush with the mirror housing.

As can furthermore be seen from the sectional illustration of FIG. 31, a closed receptacle space A is formed by the lens 551 and the cover shell 552 in the assembled state. The receptacle space A defines an installation space for receiving light means (preferably LEDs), a circuit board having electrical connectors, and optionally fiber optics.

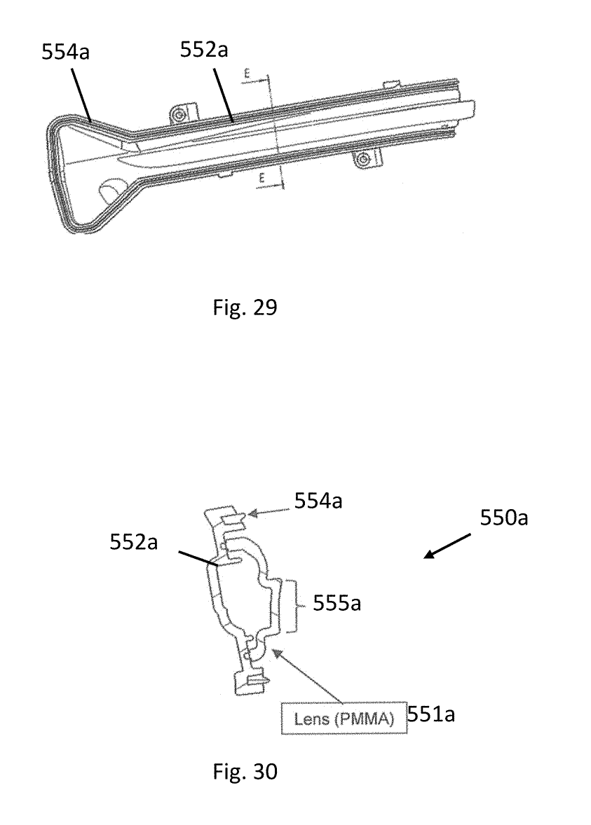

FIGS. 29 and 30 show an indicator light insert 550a such as is known. The cover shell 552a herein is produced by a bi-component injection-molding method, wherein the housing basic shell 553a is composed of ABS having an encircling seal 554a of TPA. The front cover element 551a is likewise embodied as a housing half-shell and at least in a front part-region configures a lens 555a from an at least partially transparent material or translucent material, respectively. A thermoplastic material such as PMMA is usually used as the material for the front cover element 551a. The light-permeable portion 555a is usually designed as a narrow strip-shaped portion and is composed of a transparent or of a tinted, that is to say partially transparent, plastics material. The transparent external layer can be dispensed with in the region of the non-visible external face. This is possible in the joint region between the lens 551 and the mirror housing 516. This joint region is illustrated in the sectional illustration FIG. 31. A visual distraction does not arise here since the front cover shell here engages behind the mirror housing 516.

As is shown in FIG. 29, the indicator light insert or the side turn indicator (STI) includes the seal 554a having a sealing lip. The sealing lip of the seal 554a is configured so as to seal in relation to an internal face of the mirror housing, wherein part of the lens 555a or of the cover element 551a at least partially protrudes through an opening formed in the mirror housing. According to the prior art illustrated, the sealing lip of the seal 554a is disposed so as to be spaced apart from the lens 551a, which can cause annoyances by wind noise. A further disadvantage of the known prior art lies in that tolerances can add up when joining (preferably welding) the front cover element to the rear cover shell.

As can be seen from the exterior mirror assembly according to the invention in the cross section in FIG. 31, the lens 555 by way of the front light-permeable region protrudes through the opening of the mirror housing 516, wherein a gap S is configured in an encircling manner. Therefore, a poor fit can arise when joining the indicator light insert 550 to the mirror housing 516, wherein the external face of the lens and that of the mirror housing 516 can contact one another. Since the lens 555 is formed from a PPMA material and the mirror housing is usually embodied in a painted manner, noise problems can be caused when the lens contacts the painted mirror housing.

The exterior mirror assembly 500 according to the invention having the indicator light insert 550 is shown in a sectional illustration in FIG. 31.

As is shown in FIG. 31, the indicator light insert 550 or the side turn indicator (STI) includes a seal 554 having a sealing lip that is disposed on the front cover element 551 and surrounds the visible or protruding part of the lens 555. The visible part of the lens 555 protrudes from a breakthrough or an opening in the mirror housing 516 or in the mirror cladding. The seal 554, or the sealing lip, can be adhesively bonded to the front cover element 551 or can be connected to the front cover element in another way, or can be molded directly as part of the front cover element 551, preferably by a bi-component injection-molding method. The front cover element 551 which comprises the lens 555 herein is preferably produced from PMMA, and the seal 554 is preferably produced from TPS material. The seal 554, or the sealing lip, in the assembled state bears in a sealing manner on the internal face of the mirror housing 516 and can partially extend along the horizontally running part of the front cover element 551 so as to at least partially fill the gap S between the mirror housing 516 and the lens 555. As can be seen in FIG. 31, the sealing element 554 is disposed in the region of the sidewalls 558 (horizontally running portion) of the visible part of the lens 555 and peripheries of the mirror housing 516 which surround and define the opening of the mirror housing 516.

On account of the arrangement described above of the seal 554, or the sealing lip, which is placed so as to be closer to the gap between the lens 551 and the mirror housing 516, the risk of wind noises is reduced. The gap embodiment between the lens and the mirror housing is easier to adjust. Furthermore, the risk of squeaking parts between the lens and painted parts of the mirror housing 516 in the region of the gap S is reduced by virtue of the sealing lip on and between the lens or the cover and the mirror housing. Even when the assembly is squeezed, the squeaking is avoided by virtue of the presence of the sealing lip between the lens 551 and the mirror housing 516 in all or almost all of the regions in which contact would or could be established were the sealing lip of the present invention were not to be present.

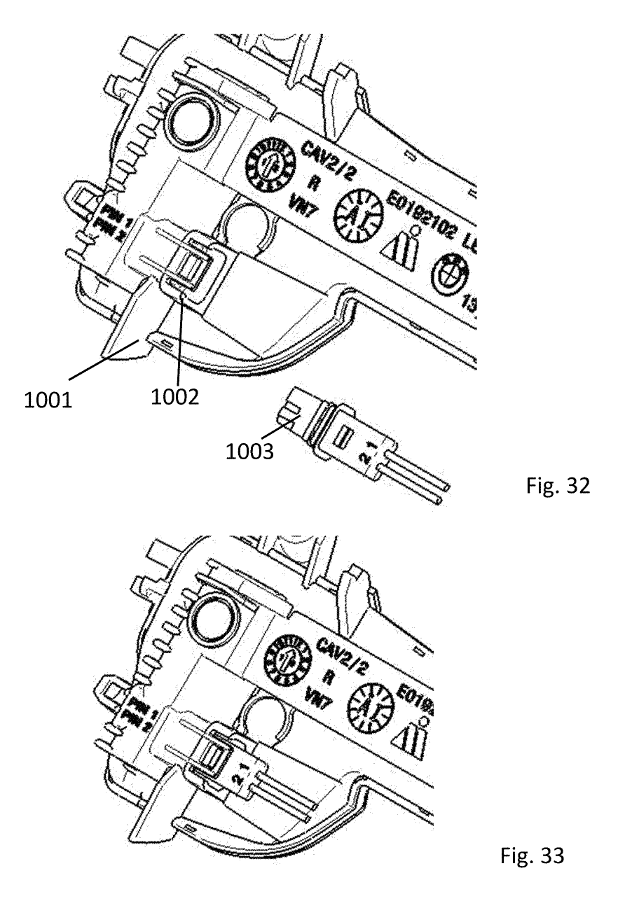

One yet further embodiment of the exterior mirror assembly 1000 according to the invention is shown in FIGS. 32-36 and will be described hereunder. The electrical connector system establishes a rapid and reliable electrical contact and connection of a light module, in particular of an indicator light insert, of an exterior mirror assembly to the vehicle electricals. With reference to the drawings and the exemplary embodiments shown therein, a light module such as, for example, an indicator light or the like of a vehicle includes a housing 1001 that has an electrical connector 1002 (such as, for example, a socket) for the electrical connection of the light to an electrical connector 1003 (such as, for example, a plug) of a vehicle cable or cable harness of the vehicle electricals of the vehicle. The electrical connection that is established when the connector 1003 of the cable harness is plugged into the socket 1002 provides a double locking mechanism so as to provide a reliable electrical contact between the electrical connector 1002 and the electrical connector 1003.

The present invention provides an additional catch 1004 on the light housing 1001, wherein the additional catch 1004 as part of the housing 1001 by way of an integral hinge connection or an integral hinge joint 1005 is molded on the interface between the housing 1001 and the catch 1004. The additional catch 1004 can be clipped to the electrical connector 1003 of the vehicle cable 1006 only when the electrical connector 1003 is situated in the orderly position on the electrical connector 1002 (the socket). The additional catch 1004 functions as a secondary locking mechanism and furthermore provides that the operator of the assembly has assembled the electrical connector 1003 (plug) in the orderly position in relation to the electrical connector 1002 (the socket and the housing) (this means that it is difficult or impossible for the connector to be wrongly assembled). The secondary locking mechanism can be opened so as to release the electrical connectors, for example when replacing a light or the like.

The housing 1001 in the case of the embodiment illustrated comprises an electric connector 1002 that is embodied as a socket which is configured so as to at least partially receive therein the electrical connector 1003 (cable harness connector) which is embodied as a plug, and to establish an electrical connection or contact. The housing 1001 comprises a secondary locking mechanism 1004 which is molded (for example, by an injection-molding process that molds the housing 1001 and the connector 1003 and that can overmold the electrically conducting pins or connectors of the electrical connector) as part of the housing 1001 and from the rear or receiving end of the housing 1001 extends on a hinge element or integral hinge 1005.

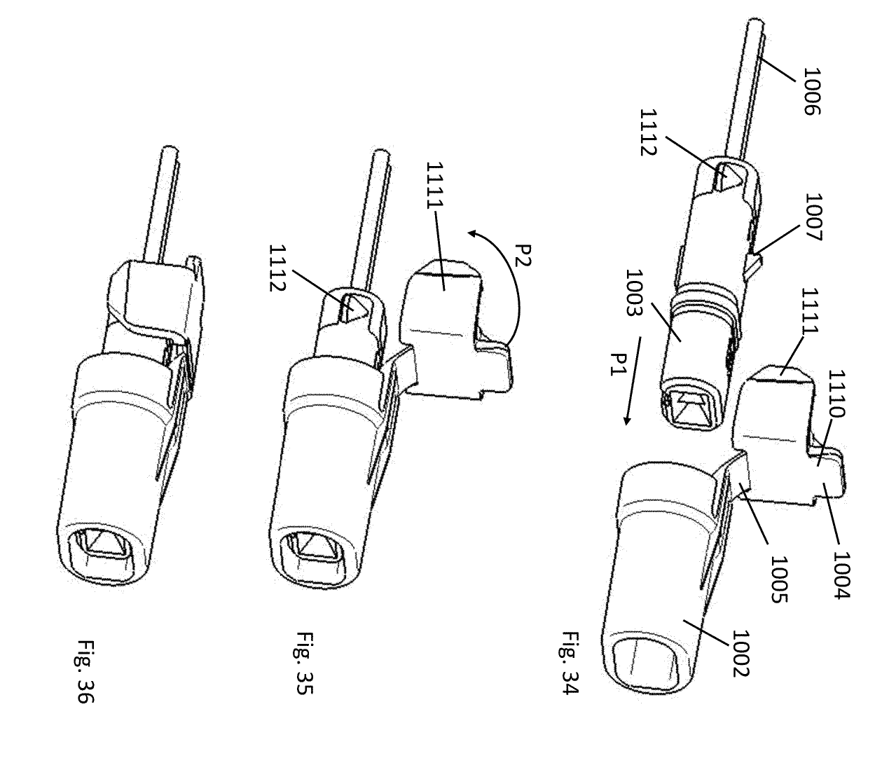

The housing 1001 includes a first catch receptacle element or tab receptacle element as a primary locking mechanism, which engages with a first catch 1007 on the electrical connector 1003 when the electrical connector/plug 1003 is introduced into the socket 1002. The first catch 1007 according to the exemplary embodiment is configured as a latching protrusion that, in the assembled situation (illustrations of FIGS. 35 and 36), engages in a latching manner in a corresponding latching depression. The corresponding latching depression/first catch or tab receptacle element is situated on an inner housing wall of the socket and cannot be seen in the drawings.

The secondary locking mechanism 1004, as has already been described above, is embodied as a pivotable flap and comprises a base element 1110 and mutually opposite lateral elements or tabs 1111 which are molded on the base element 1110. The tabs 1111 are embodied in such a manner that the tabs 1111 in the assembled state (FIG. 36) on the sides of the electrical connector 1003 can in each case be brought to engage in a latching manner with corresponding catch receptacle elements or tab receptacle elements 1112.

The assembly steps in the assembly of the electrical connector 1003 and the electrical connector 1002 are illustrated in the drawings FIGS. 34-36. In a first step, the electrical connector 1003 in the direction of the arrow P1 (FIG. 34) is connected to the electrical connector 1002 in such a manner that the latching protrusion 1007 comes to engage in a latching manner with the first catch element/latching depression (primary locking mechanism). In a subsequent second step the secondary latching mechanism/catch 1004 is pushed downward toward the electrical connector 1003, wherein the catch 1004 pivoted on account of the bending of the hinge element 1005 (see arrow P2 in FIG. 35). At the end of the pivoting movement the lateral tabs 1111 come to engage on the second catch/catch elements 1112 of the electrical connector 1003 and are locked there in a latching manner so as to fix or firmly hold the electrical connector 1003 on the socket 1002 and the housing 1001.

The present invention thus provides a double locking mechanism for holding an electrical connector/plug 1003 on a housing socket 1002. Furthermore, the connector configuration of the present invention renders a wrong assembly or connection of the connectors difficult or impossible since both elements (the electrical connector 1002 and the electrical connector 1003) have to be mutually aligned and the first connection has to be established in an orderly manner in order for the secondary locking mechanism to be able to be established.

Changes and modifications in the specifically described embodiments may be carried out without departing from the principles of the present invention, which is intended to be limited only by the scope of the appended claims as interpreted according to the principles of patent law.

1. An exterior rearview mirror assembly for a vehicle, the exterior rearview mirror assembly comprising:
a mirror head pivotally mounted at a mounting base configured for attachment at a side of a vehicle, wherein the mirror head comprises a mirror casing and a reflective element adjustably disposed at the mirror casing;
a powerfold actuator operable to pivot the mirror head relative to the mounting base between at least a folded position and a drive position;
a seal mounted at one of the mirror head or the mounting base;
wherein the seal comprises a sealing element that is configured to engage the other of the mounting base or the mirror head at least when the mirror head is not pivoting relative to the mounting base; and
wherein, when the powerfold actuator pivots the mirror head between the folded position and the drive position, the sealing element is moved away from the other of the mounting base or the mirror head such that the mirror head pivots with reduced contact of the sealing element at the other of the mounting base or the mirror head.

2. The exterior rearview mirror assembly of claim 1, wherein the sealing element is moved away from the other of the mounting base or the mirror head responsive to movement of the mirror head relative to the mounting base.

3. The exterior rearview mirror assembly of claim 1, wherein the seal is disposed around a perimeter edge region of a lift plate, and wherein a lower cover of the powerfold actuator includes at least one guide element that engages the lift plate, whereby, when the powerfold actuator pivots the mirror head between the folded position and the drive position, the lift plate pivots with the lower cover and the lift plate vertically moves relative to the lower cover to move the sealing element away from the other of the mounting base or the mirror head.

4. The exterior rearview mirror assembly of claim 3, comprising a lower element disposed at and engaged with the mounting base in a rotationally fixed manner, wherein the lower element is disposed below the lift plate and comprises cam elements that engage the lift plate and impart vertical movement of the lift plate when the lift plate is pivoted relative to the lower element.

5. The exterior rearview mirror assembly of claim 1, wherein the sealing element is moved away from the other of the mounting base or the mirror head responsive to actuation of the powerfold actuator.

6. The exterior rearview mirror assembly of claim 1, wherein at least a portion of the seal comprises a magnetic material, and wherein the exterior rearview mirror assembly comprises an electromagnetic element disposed at the seal, and wherein, when the powerfold actuator pivots the mirror head between the folded position and the drive position, the electromagnetic element is powered to move the sealing element at least partially away from the other of the mounting base or the mirror head.

7. The exterior rearview mirror assembly of claim 6, wherein the sealing element comprises a flexible lip, and wherein the flexible lip comprises a magnetic material embedded therein.

8. The exterior rearview mirror assembly of claim 6, wherein the seal comprises a deformable sealing element, and wherein the deformable sealing element has a ferromagnetic core element disposed therein.

9. The exterior rearview mirror assembly of claim 1, comprising a turn signal unit disposed at a mirror casing of the exterior rearview mirror assembly, wherein the turn signal unit, when the exterior rearview mirror assembly is disposed at a side of an equipped vehicle, is operable to emit light in a forward direction of travel of the equipped vehicle, and wherein the turn signal unit comprises a housing portion, a light source and a lens, and wherein the lens is disposed in front of the light source and wherein the lens is attached at the housing portion, and wherein the turn signal unit comprises a unit sealing element disposed at the lens, and wherein the unit sealing element engages and seals against an inside surface of the mirror casing, and wherein, with the exterior rearview mirror assembly disposed at the side of the equipped vehicle, light emitted by the light source, when powered, passes through the lens in the forward direction of travel of the equipped vehicle.

10. The exterior rearview mirror assembly of claim 9, wherein the lens comprises a visible portion that protrudes through an aperture of the mirror casing and a hidden portion that is disposed behind the mirror casing, and wherein the sealing element is disposed between the hidden portion and the inside surface of the mirror casing, and wherein the sealing element is disposed between sidewalls of the visible portion and edges of the mirror casing that circumscribe the aperture.

11. The exterior rearview mirror assembly of claim 9, wherein the sealing element is bonded to the lens or molded onto the lens.

12. The exterior rearview mirror assembly of claim 1, comprising (i) a light module having a housing and a light disposed at the housing, and (ii) a wire connector at an end of a vehicle wire harness of the vehicle equipped with the exterior rearview mirror assembly, wherein the housing comprises a receiving portion that is configured to electrically connect to the wire connector, and wherein the housing includes a first housing connector that, when the wire connector is received in the receiving portion, engages a first clip of the wire connector, and wherein the housing includes a second housing connector that is pivotally attached at the receiving portion, and wherein, when the wire connector is received in the receiving portion and when the first housing connector is engaged with the first clip of the wire connector, the second housing connector pivots onto and over part of the wire connector to engage second clips at the wire connector to retain the wire connector at the housing.

13. The exterior rearview mirror assembly of claim 12, wherein the second housing connector is pivotally attached at the receiving portion via a hinge element that is molded as part of the housing and the second housing connector, and wherein the first housing connector is formed at a junction of the hinge element and the housing.

14. The exterior rearview mirror assembly of claim 12, wherein the second housing connector comprises a pair of side tabs that partially circumscribe the wire connector to engage respective second clips at opposite sides of the wire connector.

15. An exterior rearview mirror assembly for a vehicle, the exterior rearview mirror assembly comprising:
a mirror head pivotally mounted at a mirror base configured for attachment at a side of a vehicle, wherein the mirror head comprises a mirror casing and a reflective element adjustably disposed at the mirror casing;
a powerfold actuator operable to pivot the mirror head relative to the mirror base between at least a folded position and a drive position;
wherein the powerfold actuator comprises a lift plate;
wherein a sealing element is disposed around a perimeter edge region of the lift plate;
wherein a lower cover of the powerfold actuator includes at least one guide element that engages the lift plate, whereby the lift plate pivots with the lower cover and the lift plate is vertically movable relative to the lower cover;
a lower element disposed at and engaged with the mirror base in a rotationally fixed manner, wherein the lower element is disposed below the lift plate and comprises cam elements that engage the lift plate and impart vertical movement of the lift plate when the lift plate is pivoted relative to the lower element;
wherein, when the mirror head is in the drive position, the lift plate is in a lowered position and the sealing element is disposed at and seals a gap between the mirror head and the mirror base; and
wherein, when the powerfold actuator pivots the mirror head between the folded position and the drive position, the lift plate is raised relative to the lower element and the lower cover to a raised position where the seal is disengaged from the mirror base to allow reduced friction when pivoting the mirror head between the folded position and the drive position.

16. The exterior rearview mirror assembly of claim 15, wherein a biasing element is disposed between the lift plate and the lower cover to bias the lift plate towards its lowered position.

17. The exterior rearview mirror assembly of claim 15, wherein the lift plate remains in its raised position throughout pivoting of the mirror head to the folded position and from the folded position back to the drive position.

18. The exterior rearview mirror assembly of claim 15, wherein the powerfold actuator comprises a motor that rotatably drives gears that cause pivoting of the powerfold actuator and the mirror head relative to the mirror base.

19. The exterior rearview mirror assembly of claim 15, wherein, when the powerfold actuator pivots the mirror head between the folded position and the drive position, the lower cover and the lift plate pivot together relative to the lower element and the cam elements of the lower element engage ramped surfaces of the lift plate to raise the lift plate relative to the lower element and the lower cover to the raised position.

20. The exterior rearview mirror assembly of claim 15, wherein the lift plate is disposed between the lower cover and the lower element.

21. The exterior rearview mirror assembly of claim 15, wherein the lower cover comprises a lower part of a housing of the powerfold actuator.

22. The exterior rearview mirror assembly of claim 15, wherein the lower element comprise a blocking disc of the powerfold actuator.

23. The exterior rearview mirror assembly of claim 15, wherein the lower element comprise an upper cover of the mirror base.

24. The exterior rearview mirror assembly of claim 23, wherein, when the mirror head is in the drive position, the lift plate is in the lowered position and the sealing element is disposed at and seals the gap between the mirror head and the upper cover of the mirror base.

25. An exterior rearview mirror assembly for a vehicle, the exterior rearview mirror assembly comprising:
a mirror head pivotally mounted at a mounting base configured for attachment at a side of a vehicle, wherein the mirror head comprises a mirror casing and a reflective element adjustably disposed at the mirror casing;
a powerfold actuator operable to pivot the mirror head relative to the mounting base between at least a folded position and a drive position;
a seal disposed between the mirror head and the mounting base;
wherein the seal comprises an attaching element that is attached at one of the mounting base or the mirror head;
wherein the seal comprises a sealing element that extends from the attaching element and that is configured to engage the other of the mounting base or the mirror head at least when the mirror head is not pivoting relative to the mounting base;
an electromagnetic element disposed at the seal;
wherein the electromagnetic element, when activated, draws a portion of the sealing element at least partially away from the other of the mounting base or the mirror head; and
wherein, when the powerfold actuator pivots the mirror head between the folded position and the drive position, the electromagnetic element is powered such that the mirror head pivots with reduced contact of the sealing element at the other of the mounting base or the mirror head.

26. The exterior rearview mirror assembly of claim 25, wherein, when the powerfold actuator pivots the mirror head between the folded position and the drive position, the sealing element is drawn away from the other of the mounting base or the mirror head via activation of the electromagnetic element so as to establish a gap between the sealing element and the other of the mounting base or the mirror head.

27. The exterior rearview mirror assembly of claim 25, wherein the attaching element is attached at the mounting base and the sealing element engages the mirror head at least when the mirror head is not pivoting relative to the mounting base.

28. The exterior rearview mirror assembly of claim 25, wherein the attaching element is attached at the mirror head and the sealing element engages the mounting base at least when the mirror head is not pivoting relative to the mounting base.

29. The exterior rearview mirror assembly of claim 25, wherein the electromagnetic element is actuated responsive to actuation of the powerfold actuator.

30. The exterior rearview mirror assembly of claim 25, wherein the sealing element comprises a flexible lip, and wherein the flexible lip comprises a ferromagnetic material embedded therein.

31. The exterior rearview mirror assembly of claim 25, wherein the seal comprises a deformable sealing element, and wherein the deformable sealing element has a ferromagnetic core element disposed therein.
